(19) United States
(12) Patent Application Publication
(10) Pub. No.: US 2010/0196743 A1
(43) Pub. Date: Aug. 5, 2010

(54) APPARATUS AND METHOD FOR PURGING RESIDUAL WATER AND HYDROGEN DURING SHUTDOWN OF FUEL CELL

(75) Inventors: Kyu Taek Cho, Gyeonggi-do (KR); Jong Jin Yoon, Seoul (KR); Tae Won Lim, Gyeonggi-do (KR); Soo Whan Kim, State College, PA (US); Jong Hyun Lee, Gyeonggi-do (KR); Matthew M. Mench, State College, PA (US)

Correspondence Address: EDWARDS ANGELL PALMER & DODGE LLP, P.O. BOX 55874, BOSTON, MA, 02205, US

(73) Assignees: Hyundai Motor Company, Seoul (KR); Penn State University

(21) Appl. No.: 12/363,958

(22) Filed: Feb. 2, 2009

(51) Int. Cl. H01M 8/04; H01M 8/02

(52) U.S. Cl. 429/3

(57) ABSTRACT

The present invention provides an apparatus and method for purging residual water and hydrogen during shutdown of a fuel cell, which can reduce the time required for purging residual water and hydrogen during shutdown of a fuel cell by opening and closing outlet lines of an anode and a cathode in a short period of time using solenoid valves.

### BACKGROUND

(a) Technical Field

The present invention relates to an apparatus and method for purging residual water and hydrogen during shutdown of a fuel cell. More particularly, the present invention relates to an apparatus and method for purging residual water and hydrogen during shutdown of a fuel cell, which can reduce the time required for purging residual water and hydrogen during shutdown of a fuel cell by opening and closing outlet lines of an anode and a cathode in a short period of time using solenoid valves.

(b) Background Art

Fuel cell stacks have some common technical problems during shutdown. One of them is to remove liquid water that is stored in porous media (also called a gas diffusion layer), channels, and membrane of fuel cells during normal operation. It is known that the water filled in the porous media, the channels, and pores of the membrane causes a lethargic startup and causes damage to the fuel cell stack during freezing.

Accordingly, it is necessary to purge residual liquid water in the fuel cell stack during shutdown. Additionally, it is known that residual hydrogen in the anode may cause a high open circuit potential in the cathode, which results in rapid deterioration of catalyst. To this end, some sort of anode purge with air and an auxiliary external resistor is commonly performed to remove excess hydrogen.

It is common in the art that automotive fuel cell stacks have some kind of purge during shutdown (here, the purge is defined as a flow of gas, usually a rapid flow, into the channels of the anode and cathode after the normal operation is completed and the fuel cell stack is “off”). In prior art, the purge includes flushing the anode with air, extracting the residual hydrogen with a dummy resistor, and flushing the anode with nitrogen and the cathode with a low oxygen content gas (U.S. Pat. Nos. 5,013,617 and 5,045,414). Fuel cell manufacturers use a short and strong blast purge during shutdown to remove residual water before the fuel cell stack is cooled down. Since all these purges require a great amount of energy, it is preferable to develop additional methods directed to its application and efficiency.

It has been determined experimentally that a short, rapid and steady purge has a limited effectiveness in removing water, stored in the porous media under the flow channels, or anode hydrogen. Accordingly, evidence for the lack of water removal efficiency has been provided by extensive neutron imaging experiments with water removal equipment. Moreover, in using the conventional techniques it commonly takes a considerable amount of time to remove residual hydrogen and thereby achieve a low open circuit voltage using a steady purge after shutdown. Accordingly, this purge has a large power consumption since external power should be supplied from a battery.

Furthermore, in the conventional rapid purge technique, the water and hydrogen removal efficiency is decreased when a large amount of residual water, which causes deterioration of the fuel cell durability, is present in the pores of the diffusion media (gas diffusion layer) and catalyst layers on the anode and cathode and when the residual hydrogen resides near the anode catalyst and the diffusion media, and thus the durability is compromised.

Although a long, extended and continuous purge after shutdown is suitably effective to remove water and hydrogen, it requires an extended time, it can promote degradation via local dryout of the membrane and other moisture gradients throughout the fuel cell, and it requires an excessive number of batteries due to the power required.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides an apparatus and method for suitably purging residual water and hydrogen during shutdown of a fuel cell, which can effectively remove liquid water and residual hydrogen in the fuel cell, preferably by using solenoid valves provided in outlet lines of an anode and a cathode so as to enable a pulse operation during shutdown, in which an increase and a decrease in the internal pressure of the fuel cell are alternated, and at the same time, control the acceleration and deceleration of flow in channels and porous media.

In a preferred aspect, the present invention provides an apparatus for purging residual water and hydrogen during shutdown of a fuel cell, the apparatus comprising: a solenoid valve, provided at outlet lines of an anode and a cathode, respectively; and a controller for controlling the solenoid valves to be repeatedly opened and closed for a predetermined period of time, wherein pulse purge pressure is applied to the inside of the fuel cell by the periodic opening and closing operations of the solenoid valves.

In a preferred embodiment, the pulse purge pressure is preferably applied by one of the solenoid valves.

In another aspect, the present invention provides a method for purging residual water and hydrogen during shutdown of a fuel cell, the method comprising: supplying excess hydrogen and air to an anode and a cathode, respectively, to purge residual water during shutdown of the fuel cell; and repeatedly opening and closing a solenoid valve provided at outlet lines of the anode and the cathode, respectively, for a predetermined period of time to remove residual liquid water or residual hydrogen in the fuel cell. Accordingly, the act of allowing pressure to build and be repeatedly released in the cell provides a convective flow of gas from the porous media that accelerates water and hydrogen removal compared to conventional purge flow in which no through plane flow of gas in the porous media is induced.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum).

As referred to herein, a hybrid vehicle is a vehicle that has two or more sources of power, for example both gasoline-powered and electric-powered.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a conceptual diagram showing a configuration of an apparatus for purging residual water and hydrogen during shutdown of a fuel cell in accordance with a preferred embodiment of the present invention;

FIG. 2 is a graph showing the internal pressure of the fuel cell during pulse purge in accordance with the present invention;

FIG. 3 is a graph showing water removal times taken during pulse purse in accordance with the present invention and during a conventional steady purge;

FIG. 4 is a schematic diagram showing how residual water is generated in a conventional fuel cell.

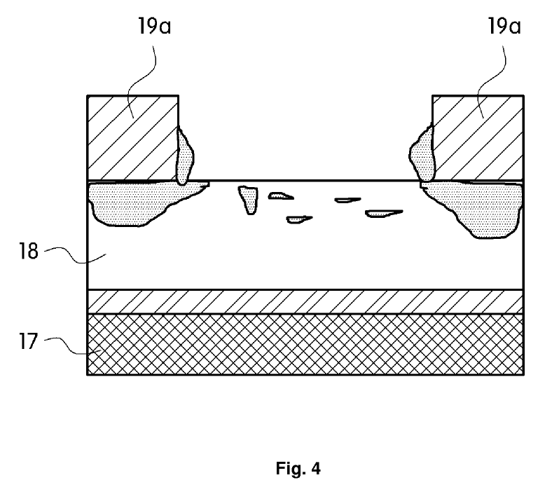

Reference numerals set forth in the Drawings includes reference to the following elements as further discussed below:

| | |
|---|---|
| 10: fuel cell | 11a: cathode inlet |
| 11b: cathode outlet | 12a: coolant inlet |
| 12b: coolant outlet | 13a: anode inlet |
| 13b: anode outlet | 14: end plate |
| 15: anode | 16: cathode |
| 17: MEA | 18: porous media (gas diffusion layer) |
| 19: bipolar plate | 19a: land portion |
| 20: solenoid valve | 21: controller |

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

In a first aspect, the invention features an apparatus for purging residual water and hydrogen during shutdown of a fuel cell, the apparatus comprising a solenoid valve and a controller, wherein pulse purge pressure is applied to the inside of the fuel cell.

In one embodiment, the solenoid valve is provided at outlet lines of an anode and a cathode, respectively.

In another embodiment, the controller controls the solenoid valves to be repeatedly opened and closed for a predetermined period of time.

In another further embodiment, the apparatus further comprises pulse purge pressure that is applied to the inside of the fuel cell by the periodic opening and closing operations of the solenoid valves. In another related embodiment, the pulse purge pressure is applied by one of the solenoid valves.

In another aspect, the invention features a method for purging residual water and hydrogen during shutdown of a fuel cell, the method comprising supplying excess hydrogen and air to an anode and a cathode and repeatedly opening and closing a solenoid valve to remove residual liquid water or residual hydrogen in the fuel cell.

In one embodiment, the excess hydrogen and air are supplied to an anode and a cathode, respectively, to purge residual water during shutdown of the fuel cell. In another embodiment, the solenoid valve, provided at outlet lines of the anode and the cathode, respectively, is opened and closed for a predetermined period of time to remove residual liquid water or residual hydrogen in the fuel cell.

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

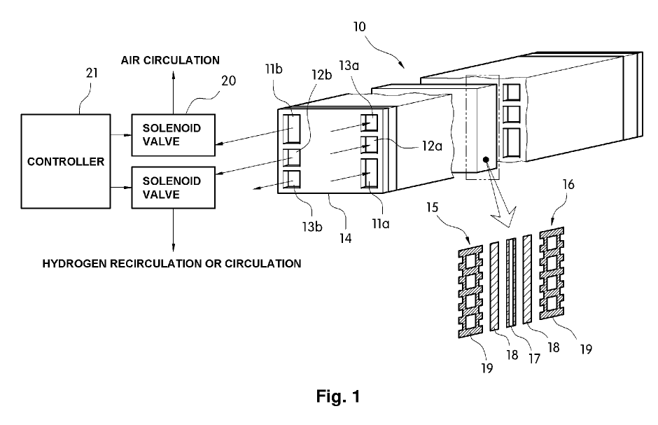

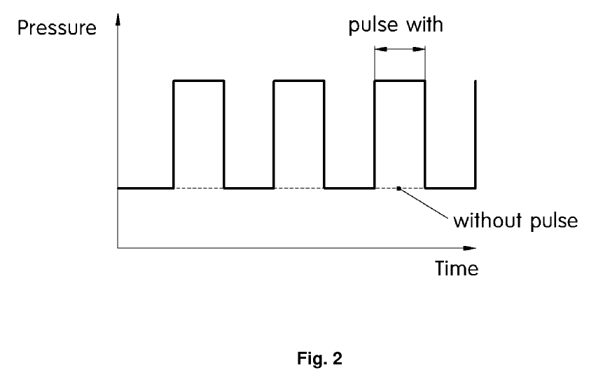

FIG. 1 is a conceptual diagram showing an exemplary configuration of an apparatus for purging residual water and hydrogen during shutdown of a fuel cell in accordance with a preferred embodiment of the present invention, FIG. 2 is a graph showing the internal pressure of the fuel cell during pulse purge in accordance with preferred embodiments of the present invention.

Preferably, according to embodiments of the invention as described herein purge is performed to reduce residual condensed water as much as possible in order to avoid difficulties in cold start, for example due to freezing in winter, and prevent deterioration of a fuel cell stack due to the residual condensed water.

According to preferred embodiments of the invention, it is known from measurements that, although a greater amount of flow than that during normal operation is preferably supplied to discharge water during purge, the amount of water is not suitably reduced below a predetermined level, even if much time has passed.

Accordingly, in other preferred embodiments, since the long duration of the purge causes a suitable increase in power consumption, it is necessary to provide a method for purging residual condensed water in the fuel cell stack within a short period of time.

Accordingly, the present invention aims at reducing the purge time by preferably providing pulse purge to an anode 15 and a cathode 16 for a suitably controlled period of time during shutdown.

In general, the purge in a fuel cell 10 is suitably defined as a flow of excess fluid into the anode 15 or the cathode 16 for a predetermined period of time to suitably discharge water produced by humidified water to the outside.

In preferred embodiments, in the pulse purge according to the present invention, solenoid valves 20 and a controller 21 are suitably provided in an anode outlet 13b and a cathode outlet 11b such that the supply of excess hydrogen for a controlled period of time, e.g., for 5 seconds, for 10 second, for 15 seconds, and the cut-off of the hydrogen supply for 5 seconds, for 10 seconds, for 15 seconds, are repeated for a predetermined period of time. In further preferred embodiments, the above pulse purge may preferably be performed only on the cathode 16.

In certain embodiments of the invention described herein, the pulse purge controls the acceleration and deceleration of the fluid flow in flow channels, and in further embodiments, into and out of the porous media, which suitably enhances drag-related purge of droplets from the channels and suitably induces a through-plane gas-phase motion.

In other further embodiments of the invention as described herein, the through-plane circulation motion in porous diffusion media (gas diffusion layer) can suitably remove residual water and hydrogen from the porous diffusion media more effectively than the steady purge, which achieves a more rapid and effective removal of residual water and hydrogen preferably without the use of a conventional purge protocol (for example, flushing the cathode 16 with air or removing residual hydrogen with a dummy resistor).

In further preferred embodiments, with the solenoid valves 20 and the controller 21 provided in the anode outlet 13b and the cathode outlet 11b in accordance with the present invention, it is thus suitably possible to realize pulse operation during shutdown, in which an increase and a decrease in the internal pressure of the fuel cell are preferably alternated, and at the same time, suitably allow the removal of liquid water stored in porous media 18 and residual hydrogen with the acceleration and deceleration of the flow in the channels.

Accordingly, the operation of the apparatus for purging residual water and hydrogen during shutdown in accordance with the preferred embodiment of the present invention will be described below.

According to preferred embodiments of the present invention, the solenoid valves 20 are preferably opened and closed repeatedly in a suitably short time period, for example, in a 5-second period, a 10 second period, a 15 second period, a 20 second period, but preferably a 5 second period, by the controller 21 such that an increase and a decrease in the internal pressure of the fuel cell are suitably alternated, thus preferably effectively removing product water and residual hydrogen, compared to the steady purge in which the purge is continuously performed.

In further exemplary embodiments, in order to prove the effect of the pulse purge in accordance with the present invention, the pulse purge using neutron imaging was suitably performed and, as a precondition for the test, considerably more residual water than the previous steady purge was fed into the fuel cell.

According to other further embodiments, the solenoid valve 20 provided at the cathode outlet 11b was preferably repeatedly turned on and off in a 5, 10, 15, 20 second, but preferably a 5-second period. According to further embodiments, at this the pulse purge was not performed on the anode 15.

Preferably, after repeatedly performing the above process, suitably for a predetermined period of time, the product water in the fuel cell was effectively removed, preferably by the 15th minute in the case of the steady purge, in which the amount of initial residual water was small, it took about 30 minutes to remove product water.

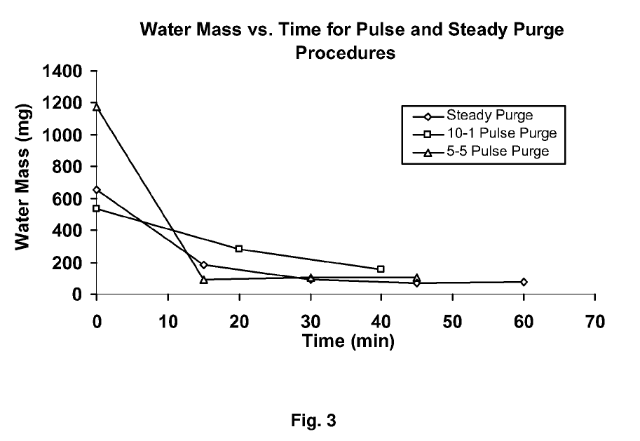

FIG. 3 is a graph showing exemplary water removal times taken during the pulse purse in accordance with the present invention and during the conventional steady purge.

As shown in the graph, in exemplary embodiments, the pulse purge of the present invention suitably removed residual water from the fuel cell more rapidly than the conventional steady purge, although the amount of initial water was larger than the conventional steady purge.

As described above, according to the apparatus and method for purging residual water and hydrogen during shutdown of a fuel cell in accordance with the present invention, the solenoid valves provided at the outlet lines of the anode and the cathode are preferably used to periodically open and close the outlet lines of the anode and the cathode so as to suitably apply a pulse to the inside of the fuel cell, thus efficiently removing liquid water and residual hydrogen in a suitably shorter period of time than the conventional steady purge.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. An apparatus for purging residual water and hydrogen during shutdown of a fuel cell, the apparatus comprising:
a solenoid valve, provided at outlet lines of an anode and a cathode, respectively; and
a controller for controlling the solenoid valves to be repeatedly opened and closed for a predetermined period of time,
wherein pulse purge pressure is applied to the inside of the fuel cell by the periodic opening and closing operations of the solenoid valves.

2. The apparatus of claim 1, wherein the pulse purge pressure is applied by one of the solenoid valves.

3. A method for purging residual water and hydrogen during shutdown of a fuel cell, the method comprising:
supplying excess hydrogen and air to an anode and a cathode, respectively, to purge residual water during shutdown of the fuel cell; and
repeatedly opening and closing a solenoid valve provided at outlet lines of the anode and the cathode, respectively, for a predetermined period of time to remove residual liquid water or residual hydrogen in the fuel cell.

4. An apparatus for purging residual water and hydrogen during shutdown of a fuel cell, the apparatus comprising:
a solenoid valve; and
a controller,
wherein pulse purge pressure is applied to the inside of the fuel cell.

5. The apparatus of claim 4, wherein the solenoid valve is provided at outlet lines of an anode and a cathode, respectively.

6. The apparatus of claim 4, wherein the controller controls the solenoid valves to be repeatedly opened and closed for a predetermined period of time.

7. The apparatus of claim 4, further comprising pulse purge pressure that is applied to the inside of the fuel cell by the periodic opening and closing operations of the solenoid valves.

8. The apparatus of claim 4, wherein the pulse purge pressure is applied by one of the solenoid valves.

9. A method for purging residual water and hydrogen during shutdown of a fuel cell, the method comprising:
supplying excess hydrogen and air to an anode and a cathode; and
repeatedly opening and closing a solenoid valve to remove residual liquid water or residual hydrogen in the fuel cell.

10. The method of claim 8, wherein the excess hydrogen and air are supplied to an anode and a cathode, respectively, to purge residual water during shutdown of the fuel cell.

11. The method of claim 8, wherein the solenoid valve, provided at outlet lines of the anode and the cathode, respectively, is opened and closed for a predetermined period of time to remove residual liquid water or residual hydrogen in the fuel cell.
